(19) United States
(12) Patent Application Publication
(10) Pub. No.: US 2025/0153124 A1
(43) Pub. Date: May 15, 2025

(54) Gypsum Calcining Apparatuses and Methods

(71) Applicant: UNITED STATES GYPSUM COMPANY, Chicago, IL (US)

(72) Inventors: Blair Chylds Walker, Almonte (CA); Dayakar Thoddu Chandrasekaran, Naperville, IL (US)

(21) Appl. No.: 18/775,091

(22) Filed: Jul. 17, 2024

Related U.S. Application Data
(60) Provisional application No. 63/597,826, filed on Nov. 10, 2023.

(51) Int. Cl. B01J 6/00; C04B 11/028

(52) U.S. Cl. CPC B01J 6/004; C04B 11/028; B01J 2219/00157; B01J 2219/00777

(57) ABSTRACT

An apparatus for calcining gypsum includes a housing, at least one burner assembly, and at least one baffle. The housing has opposite first and second lateral walls, an inlet, and an outlet. The at least one burner assembly is connected to the housing, and can include a burner, a fluidization plenum, and a serpentine burner conduit. The serpentine burner conduit at least partly extends through the housing and to the fluidization plenum. The at least one baffle is disposed in the housing and attached to one of the first and second lateral walls. The baffle extends at least partly across the housing toward the other of the first and second lateral walls to define a flow path for the gypsum. The flow path extends from the inlet, around the baffle, and to the outlet.

### CROSS-REFERENCE TO RELATED APPLICATIONS

Priority is claimed to U.S. Provisional Patent Application No. 63/597,826, filed Nov. 10, 2023, the entire contents of which are hereby incorporated by reference herein.

### FIELD OF THE DISCLOSURE

The present disclosure relates to apparatuses and methods for calcining gypsum and, more particularly, to high-efficiency apparatuses and methods for calcining gypsum.

### BACKGROUND

Calcining gypsum includes converting calcium sulfate dihydrate by heating it into calcium sulfate hemihydrate, better known as stucco. Prior calcining apparatuses and methods have taken various forms. Traditionally, the calcining of gypsum has occurred in a large apparatus, having a thickened dome-shaped bottom, against which a gas-fired flame is directed, with the apparatus and burner flame being enclosed in a suitable refractory structure. There is usually an associated hot pit into which the calcined material is fed. The apparatus must withstand temperatures in the 2,000°-2,400° F. range, hence requiring expensive fire box steel plate on its domed bottom, which was typically 1¾ inches thick.

Other calcining apparatuses, of the general type described above, have included supplemental submerged combustion designs where exhaust gases from the gas-fired burners were discharged directly into the apparatus contents. Here, the gas flame directly impinged against the material being calcined, and there was an increased possibility of creating so-called “dead burn” material, i.e., insoluble anhydrite. Additionally, other calcining apparatuses, of the general type described above, included a series of cross burner tubes which passed generally horizontally completely through the apparatus, allowing the hot gases within the refractory structure and surrounding the apparatus to be supplementally directed through the tubes, and thus, through the apparatus contents to further heat the same. There have also been horizontally-aligned, rotary calcining structures.

Besides the above apparatus constructions which normally require expensive refractory structure, there have also been refractoryless apparatuses using the submerged combustion principle, including those having auxiliary draft tube structure encompassing the main burner tube, so as to reduce formation of dead-burned insoluble anhydrite. Additionally, there are so-called refractoryless conical apparatuses with various types of submerged combustion heating systems, again with the attendant risk of creating non-uniform stucco and dead burn material. Still further calcining apparatus modifications have included so-called “boost” burner constructions, including electrical boost calrods, and gas-fired boost burner designs, both added as supplemental heaters to traditional refractory-type apparatus constructions. Still other refractoryless apparatus designs include a multiple series of separate immersion tube coils, each coil operating within a specific calcining zone inside the apparatus.

### SUMMARY

One aspect of the disclosure is directed to an apparatus for calcining gypsum. The apparatus can include a housing, at least one burner assembly, and at least one baffle. The housing can have opposite first and second lateral walls, an inlet, and an outlet. The at least one burner assembly is connected to the housing, and can include a burner, a fluidization plenum, and a serpentine burner conduit. The serpentine burner conduit at least partly extends through the housing and to the fluidization plenum. The at least one baffle is disposed in the housing and attached to one of the first and second lateral walls. The baffle extends at least partly across the housing toward the other of the first and second lateral walls to define a flow path for the gypsum. The flow path extends from the inlet, around the baffle, and to the outlet.

In some aspects, the at least one burner assembly includes at least first and second vertical burner assemblies including respective first and second vertical serpentine burner conduits, and the baffle is a vertical baffle disposed at least partly between the first and second vertical serpentine burner conduits.

In some aspects, the at least one burner assembly includes at least one horizontal burner assembly including a horizontal serpentine burner conduit, and the baffle is a vertical baffle disposed at least partly in a U-shaped portion of the horizontal serpentine burner conduit.

In some aspects, the at least one horizontal burner assembly includes at least first and second horizontal burner assemblies including respective first and second horizontal serpentine burner conduits, and the vertical baffle is disposed at least partly in corresponding U-shaped portions of the first and second serpentine burner conduits.

In some aspects, the at least one burner assembly includes a single burner assembly including a single serpentine burner conduit, and the baffle includes a plurality of flat metal plate portions dividing the housing into separate first and second housing portions. The single serpentine burner conduit can include a first half disposed in the first housing portion and a second half disposed in the second housing portion.

In some aspects, the at least one burner assembly includes at least first, second, and third burner assemblies including corresponding first, second, and third serpentine burner conduits. The at least one baffle includes first and second baffles. The first baffle is attached to the first lateral wall and extending at least partly across the housing toward the second lateral wall between the first and second serpentine burner conduits. The second baffle is attached to the second lateral wall and extending at least partly across the housing toward the first lateral wall between the second and third serpentine burner conduits.

In some aspects, the at least one burner assembly incudes at least first, second, and third burner assemblies including corresponding first, second, and third serpentine burner conduits. The at least one baffle includes first and second baffles. The first baffle is attached to the first lateral wall and extending at least partly across the housing toward the second lateral wall and within corresponding first U-shaped portions of the first and second serpentine burner conduits. The second baffle is attached to the second lateral wall and extending at least partly across the housing toward the first lateral wall and within corresponding second U-shaped portions of the first and second serpentine burner conduits.

In some aspects, the burner of the at least one burner assembly is located proximate a top of the housing, proximate a bottom of the housing, or proximate a side of the housing.

In some aspects, the at least one burner assembly includes first and second burner assemblies including corresponding first and second serpentine burner conduits. The first and second burner assemblies further include corresponding first and second fluidization plenums such that the first and second serpentine burner conduits exhaust into the corresponding first and second fluidization plenums. The first and second fluidization plenums separated from one another.

In some aspects, a space is disposed between the first and second fluidization plenums.

In some aspects, a divider is disposed between the fluidization plenums.

Another aspect of the present disclosure is directed to a method of calcining gypsum. The method can include providing gypsum to an inlet of a housing of a calcining apparatus. The method can further include directing the flow of gypsum through the housing and around at least one baffle disposed in the housing, the baffle attached to one of a first and a second lateral wall of the housing and extending at least partly across the housing toward the other of the first and second lateral walls. The method can further include heating the gypsum via conduction heat transfer with at least one serpentine burner conduit disposed in the gypsum in the housing as the gypsum is directed through the housing and around the at least one baffle, the serpentine burner conduit extending from a burner and through the housing. The method can further include flowing exhaust gas from the serpentine burner conduit through a fluidization plenum disposed adjacent a bottom wall of the housing. The method can further include fluidizing and further heating the gypsum via convection heat transfer by flowing the exhaust gas from the at least one serpentine burner conduit through the gypsum in the housing.

In some aspects, directing the flow of gypsum includes directing the flow of gypsum around at least one vertical baffle disposed at least partly between at least two vertical serpentine burner conduits.

In some aspects, directing the flow of gypsum includes directing the flow of gypsum around at least one vertical baffle disposed at least partly in a U-shaped portion of the least one serpentine burner conduit.

In some aspects, directing the flow of gypsum includes directing the flow of gypsum around at least one vertical baffle including a plurality of flat metal plate portions dividing the housing into separate first and second housing portions, and around a single serpentine burner conduit including a first half disposed in the first housing portion and a second half disposed in the second housing portion.

In some aspects, directing the flow of gypsum includes directing the flow of gypsum around at least first and second baffles, the first baffle attached to the first lateral wall and extending at least partly across the housing toward the second lateral wall between a first serpentine burner conduit and a second serpentine burner conduit, and the second baffle attached to the second lateral wall and extending at least partly across the housing toward the first lateral wall between the second serpentine burner conduit and a third serpentine burner conduit.

In some aspects, directing the flow of gypsum includes directing the flow of gypsum around at least first and second baffles, the first baffle attached to the first lateral wall and extending at least partly across the housing toward the second lateral wall and within a first U-shaped portion of at least first and second serpentine burner conduits, and the second baffle attached to the second lateral wall and extending at least partly across the housing toward the first lateral wall and within a second U-shaped portion of the at least first and second serpentine burner conduits.

In some aspects, heating the gypsum includes heating a plurality of serpentine burner conduits with a plurality of corresponding burners located proximate a top of the housing, proximate a bottom of the housing, or proximate a side of the housing.

In some aspects, heating the gypsum includes heating the gypsum with at least two serpentine burner conduits and wherein flowing exhaust gas from the at least two serpentine burner conduits includes flowing the exhaust gas through at least two fluidization plenums separated from one another.

In some aspects, flowing exhaust gas through at least two fluidization plenums includes flowing exhaust gas through at least two thermally isolated fluidization plenums.

### BRIEF DESCRIPTION OF THE DRAWINGS

FIG. 1 is an isometric view of an apparatus for calcining gypsum in accordance with the teachings of this disclosure.

FIG. 2 is an isometric view of a portion of the apparatus of FIG. 1 with the top and sides of the housing omitted.

FIG. 3 is an isomeric view of another portion of the apparatus of FIG. 1 with the top and sides of the housing and the serpentine burner conduits omitted.

FIG. 4 is a detailed view of a portion of the apparatus of FIG. 3 showing lobes of a cam shaft positioned between corresponding cam followers.

FIG. 5 is an isometric view of an agitation assembly of the apparatus of FIG. 1.

FIG. 6 shows fluidization plenums and a floor of the housing of the apparatus of FIG. 1.

FIG. 7 is a schematic top view of another implementation of an apparatus in accordance with the teaching of this disclosure.

FIG. 8 is a schematic top view of another implementation of an apparatus in accordance with the teaching of this disclosure.

FIG. 9 is a side view of another implementation of an apparatus in accordance with the teaching of this disclosure.

FIG. 10 is a perspective view of another implementation of an apparatus in accordance with the teaching of this disclosure.

FIG. 11 is a top view of the implementation of FIG. 10.

FIG. 12 is a side view of the implementation of FIG. 10.

FIG. 13 is a perspective view of another implementation of an apparatus in accordance with the teaching of this disclosure.

FIG. 14 is a top view of the implementation of FIG. 13.

FIG. 15 is a side view of the implementation of FIG. 13.

### DETAILED DESCRIPTION

The present disclosure relates to example apparatuses and methods for calcining gypsum that allow for more precise control of process parameters including, for example, heat generation, pressure, and/or backpressure in the apparatus, and/or uniformity of gas distribution through the gypsum. To do so, some of the disclosed apparatuses include at least two burner assemblies that each include a burner, a fluidization plenum, and a serpentine burner conduit extending between the burner and the fluidization plenum. The disclosed apparatuses may be configured to more efficiently calcine gypsum using a reduced amount of floor space and less overall supplemental equipment such as equipment used to load the apparatus. The burner assemblies may be independently operable enabling maintenance to be performed on one of the burner assemblies while the other burner assembly is operating. The fluidization plenums may be separated, spaced, and/or thermally isolated from one another to enable the fluidization plenums to independently exist. The present disclosure also relates to example apparatuses and methods for calcining gypsum with more precise control via an apparatus with a housing, at least one burner assembly, and at least one baffle disposed in the housing such that the flow of gypsum is directed around the baffle and through the housing. The presence of at least one baffle, as disclosed, can assist with optimizing heat transfer and calcining by staging cross-flow, creating a plug-like flow, and/or a counter current flow in the housing.

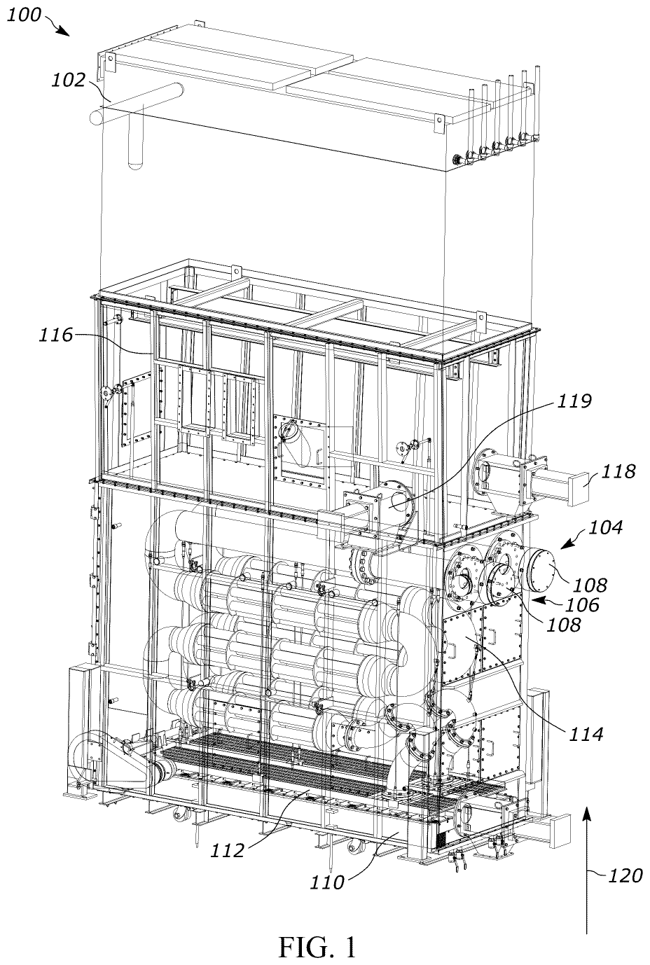

FIG. 1 is an isometric view of an apparatus 100 for calcining gypsum in accordance with the teachings of this disclosure. The apparatus 100 includes a housing 102 and a pair of burner assemblies 104, 106 positioned within the housing 102. Each burner assembly 104, 106 includes a burner 108, a fluidization plenum 110, an agitation frame 112 positioned over the fluidization plenum 110, and a serpentine burner conduit 114 extending through the housing 102 between the burner 108 and the fluidization plenum 110. The serpentine burner conduits 114 are disposed in a common reaction area of the housing 102 for calcining gypsum. And as will be discussed in more detail below, the fluidization plenums 110 of the burner assemblies 104, 106 are separate from one another. The housing 102 also includes an inlet 116 and an outlet 118, 119. The inlet 116 is configured to receive gypsum powder and the outlet 118, 119 is configured to exhaust processed calcined gypsum from the housing 102 during operation. The apparatus 100 is shown including a primary outlet 118 and a secondary outlet 119. The apparatus 100 may alternatively include a single outlet or more than two outlets. While the apparatus 100 in FIG. 1 is illustrated as including a pair of burner assemblies 104, 106, other apparatuses in accordance with this disclosure can include a single burner assembly, at least two burner assemblies, at least three burner assemblies, at least four burner assemblies, etc.

Each burner assembly 104, 106 may be an independent system that fires into its own separate serpentine burner conduit 114 allowing for indirect heat transfer to the media (e.g., gypsum) contained within the apparatus 100. The burner assemblies 104, 106 may be controlled by a common thermocouple or separate thermocouples.

Upon operation, each burner 108 fires into the corresponding serpentine burner conduit 114. The combustion gas travels through the serpentine burner conduits 114 and enters the separate fluidization plenums 110 at the bottom of the housing 102. The serpentine burner conduits 114 are constructed of a metallic material or some other heat conductive material. Therefore, the firing of the burners 108 and passage of exhaust gases through the serpentine burner conduits 114 increases the temperature of the serpentine burner conduits 114. As such, the serpentine burner conduits 114 can heat the gypsum material in the housing 102 by way of conduction heat transfer.

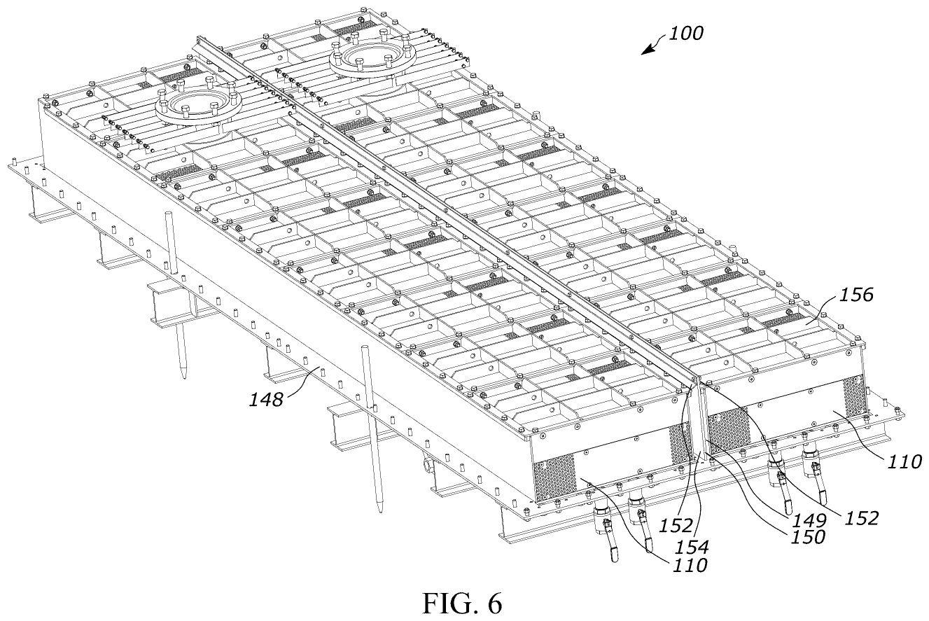

As the exhaust gas from the serpentine burner conduits 114 fills the separate fluidization plenums 110, pressure increases therein, causing the exhaust gas to ultimately flow upwardly out of the fluidization plenums 110 in a direction generally indicated by arrow 120 in FIG. 1. To facilitate this upward flow, the fluidization plenums 110 include fluidization pads 156 (shown in FIG. 6) for evenly distributing the exhaust flow as it passes out of the fluidization plenums 110. The fluidization pads 156 are disposed across the top of the fluidization plenums 110 and can be constructed of a porous material. In some versions, the fluidization pad 156 can include at least one intermediate porous layer, formed of a porous fiber mat, woven stainless steel media, or other suitable material, positioned between the outer perforated plates for structural support. In other versions, the outer perforated plates may be omitted.

As such, the fluidization plenums 110 distribute the exhaust gases upward through the gypsum product contained within the housing 102 so that the heated exhaust gases are evenly distributed therethrough. So arranged, the exhaust gases further heat the gypsum in the housing 102 by way of convection heat transfer. The combustion air of each burner 108 comes together inside the reaction area of the housing 102 as the combustion air fluidizes through the media (e.g., gypsum) within the housing 102. The separate fluidization plenums 110 advantageously allows the apparatus 100 to more precisely control pressure accumulation and/or backpressure within each fluidization plenum 110. For example, in some versions, the apparatus 100 can include pressure sensors disposed in or associated with the fluidization plenums 110, which transmit signals back to a controller. The controller may be set to operate the burners 108 (e.g., together or independently) in a manner to achieve a target pressure in each of the fluidization plenums 110, thereby optimizing fluidization of the exhaust gas through the housing 102. This way, the apparatus 100 can in some versions ensure that the exhaust gas is more evenly distributed upwardly through the gypsum contained within the housing 102. In addition to facilitating more precise pressure and temperature control, the separation of the fluidization plenums 110 allows the fluidization plenums 110 to thermally expand and/or contract without adversely affecting each other. This further ensures precise control of operational parameters by ensuring a consistently predictable geometric volume inside of the fluidization plenums 110.

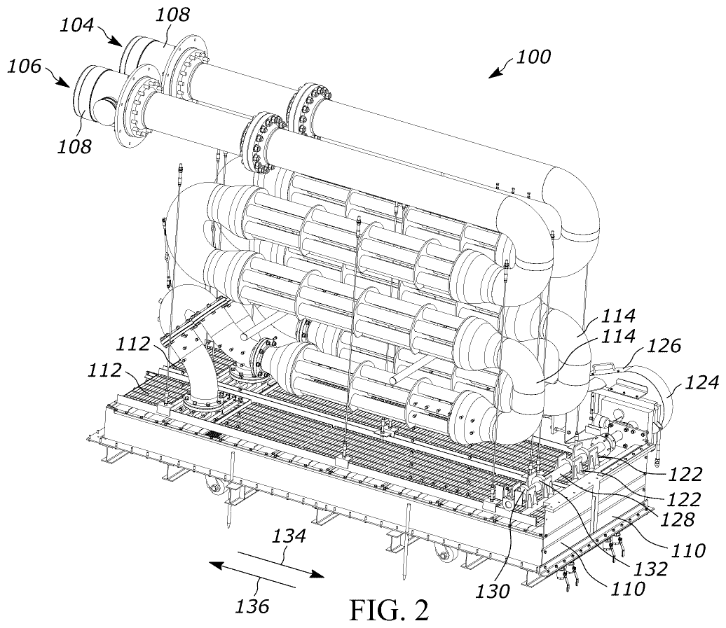

FIG. 2 is an isometric view of a portion of the apparatus 100 of FIG. 1 with the top and sides of the housing 102 omitted. Each agitation frame 112 includes a pair of cam followers 122 configured to be driven be an agitation assembly 124. The agitation assembly 124 includes a motor 126 and a cam shaft 128. The cam shaft 238 is shown featuring eccentric cams. The cam shaft 128 includes lobes 130 positioned in a space 132 defined between corresponding cam followers 122. The motor 126 rotates the cam shaft 128 and the lobes 130 in operation, which causes the lobes 130 to engage the corresponding cam followers 122 and move the agitation frames 112 relative to the fluidization plenum 110. More specifically, as the motor 126 rotates the cam shaft 128, the lobes 130 alternatingly engage the cam followers 122 causing each agitation frame to slidingly reciprocate back and forth immediately above the respective fluidization plenums 110. The engagement between the lobes 130 and the corresponding cam followers 122 moves the agitation frames 112 in opposing directions represented by arrows 134, 136 in FIG. 2. As such, in the disclosed version, the agitation frames 112 move out of phase in order to disturb the presence of any media (e.g., gypsum) that may otherwise collect on top of the fluidization plenums 110 and/or to reduce the load imparted on the motor 126. The term “out of phase” means that the lobes 130 of one of the agitation frames 112 lags the lobes 130 of the other agitation frames 112. The lobes 130 may be 90 degrees out of phase when the lobes 130 are out of phase. The cam shaft 328 may alternatively move the agitation frames 112 in opposite phase. The lobes 130 may be 180 degrees out of phase when the lobes 130 are in opposite phase. The term “opposite phase” means that the two agitation frames 112 move in a manner in which when one of the agitation frames 112 is moving to the left, the other agitation frame 112 is moving to the right until each reaches its end of travel, at which point, each changes direction. In alternative versions, the lobes 130 on the cam shaft 128 could be arranged to drive the agitation frames 112 in a common phase, i.e., where the frames 112 move together in sync and/or arranged to provide a dwell period between the movement of the agitation frames 112.

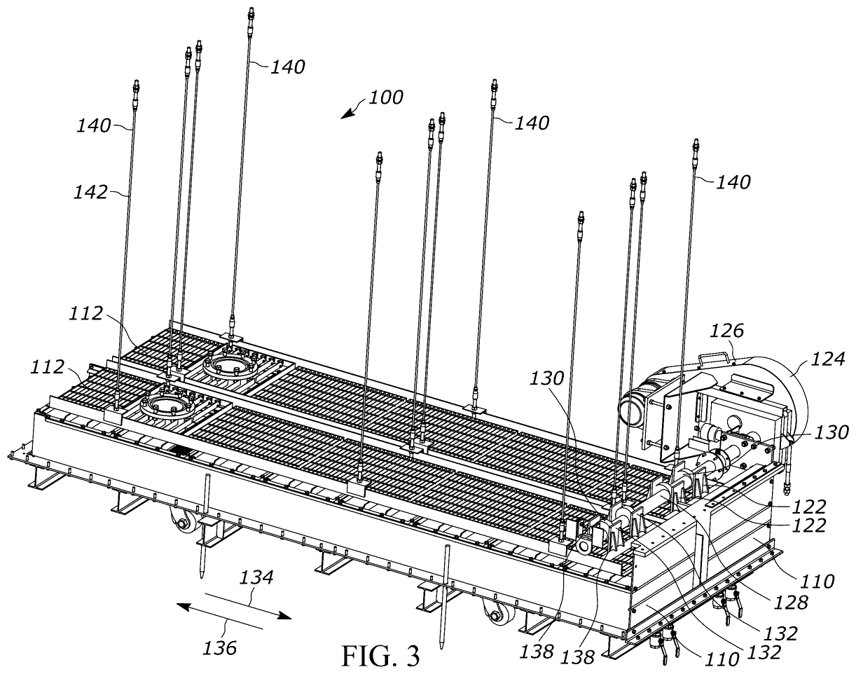

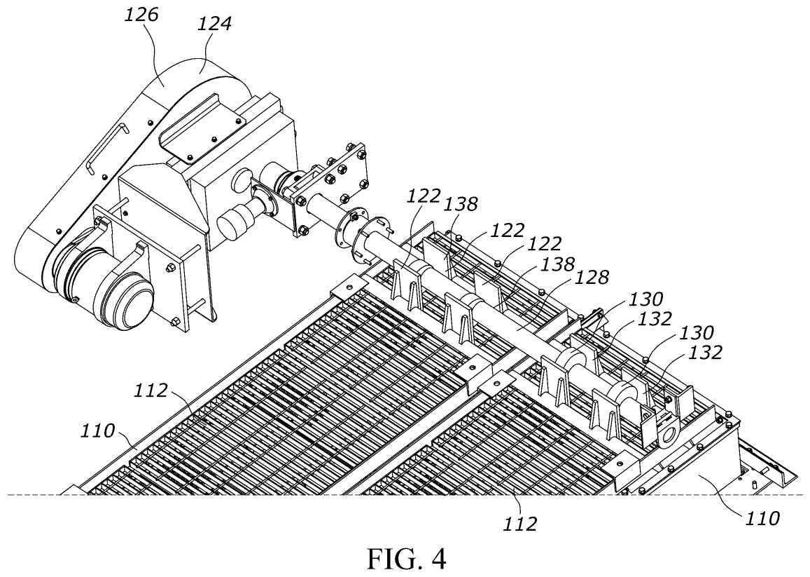

FIG. 3 is an isomeric view of another portion of the apparatus 100 of FIG. 1 with the top and sides of the housing 102 and the serpentine burner conduits 114 omitted. Each of the pairs of cam followers 122 has opposing flat faces 138 that are engaged by the lobes 130. The cam followers 122 are rigidly coupled to the agitation frames 112 and may be referred to as flat-cam followers. This can be seen in FIG. 4, for example, which is a detailed view of the portion of the apparatus 100 of FIG. 3 showing the lobes 130 of the cam shaft 128 positioned in the space 132 defined between the corresponding cam followers 122.

Referring back to FIG. 3, support arms 140 are also shown for coupling the agitation frames 112 to the housing 102. The support arms 140 include bottom ends connected to the agitation frames 112 and upper ends adapted to be connected to interior aspects of the housing 102 such that the support arms 140 act as pivotal support arms 142, allowing the agitation frames 112 to easily move (e.g., swing) in the directions indicated by arrows 134, 136 when the agitation assembly 124 imparts motion to the agitation frames 112.

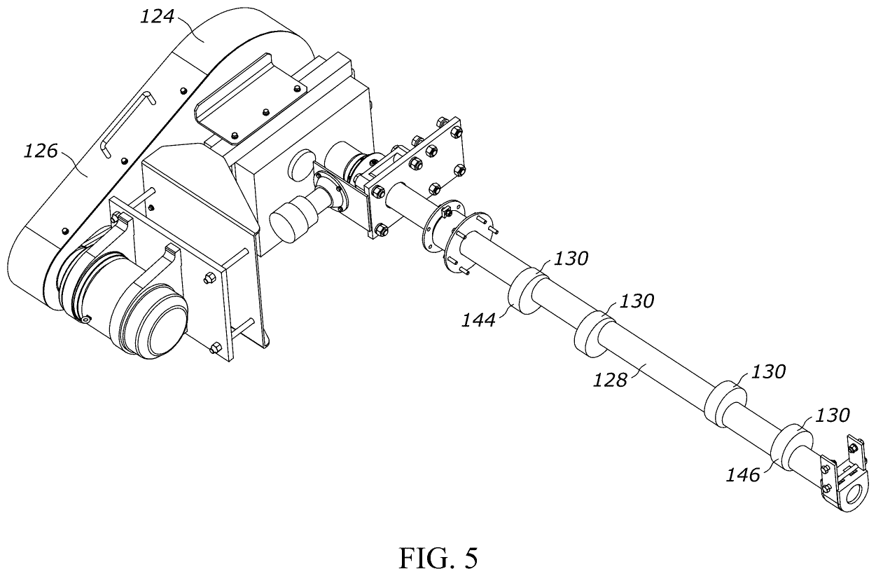

FIG. 5 is an isometric view of the agitation assembly 124 of the apparatus 100 of FIG. 1. The lobes 130 in the implementation shown include first lobes 144 and second lobes 146. The first lobes 144 are associated with a first one of the agitation frames 112 and the second lobes 146 are associated with a second one of the agitation frames 112. The first lobes 144 are thus used to move one of the agitation frames 112 and the second lobes 146 are used to move the other one of the agitation frames 112. The first lobes 144 are positioned approximately 90 degrees relative to the second lobes 146. The positioning of the lobes 144, 146 allows the lobes 144, 146 to not be top and bottom dead center at the same time such that one of the pairs of lobes 144, 146 will lag the other pair of lobes 144, 146. The lobes 144, 146 may be differently positioned, however. While the lobes 144, 146 are shown out of phase, the lobes 144, 146 may be in common phase and/or in opposite phase. The positioning of the first lobes 144 and the second lobes 146 allows the agitation assembly 124 to move the agitation frames 112 in a manner that enables the first lobes 144 to engage a cam follower 122 and move the associated agitation frame 112 in the direction generally indicated by arrow 134 and then the second lobes 146 engages a cam follower 122 and move the associated agitation frame 112 in the direction generally indicated by arrow 136. The frames 112 may be moved in a manner that reduces the load imparted on the motor 126.

FIG. 6 shows the fluidization plenums 110 and a floor 148 of the housing 102 of the apparatus 100 of FIG. 1. As illustrated, the two fluidization plenums 110 are separate from one another. In FIG. 6, the two fluidization plenums 110 are separated from one another by a space 149. The space 149 can substantially thermally isolate the fluidization plenums 110 from one another. The phrase substantially thermally isolates as set forth herein means that the fluidization plenums 110 can thermally expand and/or contract without adversely affecting each other. In the depicted version, a divider 150 is disposed in the space 149 between the plenums 110 and extends from the floor 148 of the housing 102 slightly above the two fluidization plenums 110. The depicted version further includes a diversion plate 152 disposed at (e.g., along) an upper edge of the divider 150. The diversion plate 152 may include two plate portions on opposite sides of a peak, each plate portion having a pitch that extends at an angle down and away from the peak. In the depicted version, the peak of the diversion plate is located along the upper edge of the divider 150 and the opposite edges of the two plate portions rest adjacent to (e.g., in contact with, in close proximity to, etc.) upper surfaces of the fluidization plenums 110. But alternative versions do not necessarily need the divider 150 such that the diversion plate 152 can be connected directly to and/or supported by the adjacent fluidization plenums 110.

Regardless of the presence of the divider 150, the diversion plate 152 can deter gypsum from entering the space 149 between the burner assemblies 104, 106, and specifically, the space between the fluidization plenums 110. In some versions, the diversion plate 152 may act as a seal that seals the space 149 between the fluidization plenums 110 and/or deters gypsum from entering the space 149 between the fluidization plenums 110. If gypsum were to enter and/or fill the space 149 between the fluidization plenums 110, the ability of the fluidization plenums 110 to expand and/or contract under high temperature could be impaired. In some versions, an insulating material 154 (e.g., stuffing) may be positioned within the space 149 between the fluidization plenums 110. The insulation 154 could partially or completely fill the space 149. In versions that include the divider 150, the insulation 154 could fill the space 149 on either or both sides of the divider 150. The insulation 149 154 further thermally isolates the fluidization plenums 110 and enables the fluidization plenums 110 to expand and/or contract under high temperatures. Finally, the insulation 154 can also assist with deterring gypsum from entering the space 149 between the fluidization plenums 110.

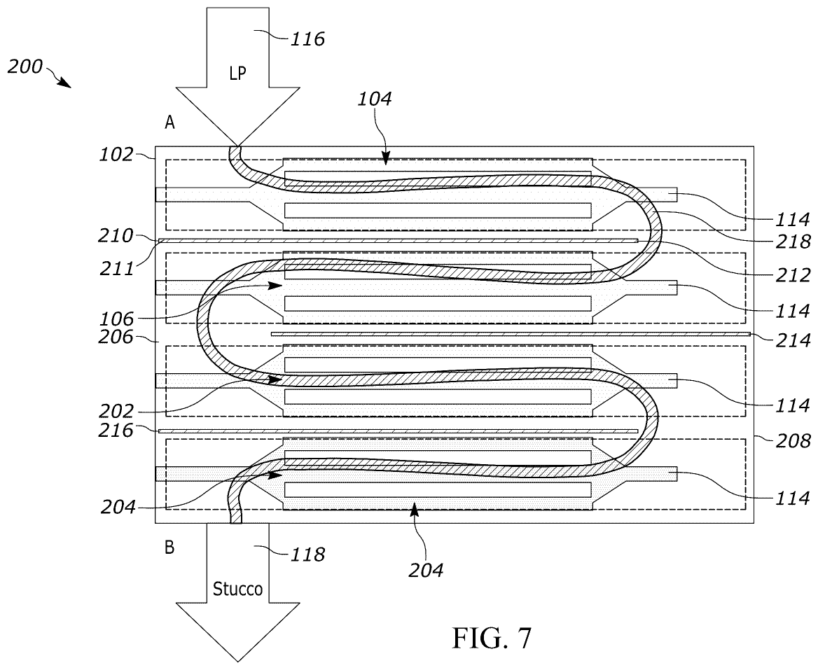

FIG. 7 is a schematic top view of another implementation of an apparatus 200 in accordance with the teaching of this disclosure. The apparatus 200 includes all of the same features as the apparatus 100 of FIG. 1 but includes four burner assemblies 104, 106, 202, 204 instead of two burner assemblies 104, 106. As with the burner assemblies 104, 106 described above with reference to FIG. 1, each burner assembly 104, 106, 202, 204 in FIG. 7 includes a burner, a fluidization plenum, an agitation frame, and a serpentine burner conduit. However, in alternative versions, it is possible that any one of more of the burner assemblies 104, 106, 202, 204 in FIG. 7 can share a burner, a fluidization plenum, and/or an agitation frame. The housing 102 of the apparatus 200 has a first lateral wall 206, a second lateral wall 208, a first baffle 210, a second baffle 214, and a third baffle 216. The first baffle 210 is coupled to the first lateral wall 206 and extends between the serpentine burner conduits 114 of the first and second burner assemblies 104, 106. The first baffle 210 is spaced from the second lateral wall 208. The first baffle 210 includes a flat metal plate with a first edge 211 connected to the first lateral wall 206, and an opposite second edge 212 spaced from the opposite lateral wall 208. A bottom edge of the first baffle 210 and a top edge of the first baffle 210 may be floating in some examples. The bottom edge of the first baffle 210 may be floating in some examples to allow the agitation assembly 124 to move below and relative to the first baffle 210. The top edge of the first baffle 210 may be coupled to the top of the housing 102 and/or may be free floating.

The second baffle 214 is generally constructed the same as the first baffle 210, but is coupled to the second lateral wall 208 and is spaced from the first lateral wall 206, extending between the serpentine burner conduits 114 of the second and third burner assemblies 106, 202. The third baffle 216 is also generally constructed the same as the first and second baffles 210, 214, but like the first baffle 210, the third baffle 216 is coupled to the first lateral wall 206 and is spaced from the second lateral wall 208, extending between the third and fourth burner assemblies 202, 204. In the implementation of FIG. 7, the baffles 210, 214, 216 may be referred to as vertical baffles. As the baffles 212, 214, 216 alternatingly extend from opposite first and second lateral walls 206, 208 of the housing 102, the baffles can be called alternating baffles.

The baffles 210, 214, 216 encourage the flow of gypsum through the housing 102 along a tortuous path generally indicated by arrow 218 in FIG. 7. So configured, the gypsum flows from the inlet 116, along and past the first burner assembly 114, and through the space between the first baffle 210 and the second lateral wall 208. Then, the gypsum flows along and past the second burner assembly 114, and through the space between the second baffle 214 and the first lateral wall 206. Then, the gypsum flows along and past the third burner assembly 114, and through the space between the third baffle 216 and the second lateral wall 208. And finally, the gypsum flows along and past the fourth burner assembly 114, and to the outlet 118. Thus, the baffles 210, 214, 216 direct the flow of the gypsum by restricting flow to the desired flow path 218. The flow of the gypsum in a direction generally indicated by the arrow 218 may be referred to as “plug flow.” The gypsum flowing in this manner may allow for more uniform heating of the gypsum and/or more uniform gypsum conversion, thereby avoiding some gypsum being over cooked and some gypsum being under cooked.

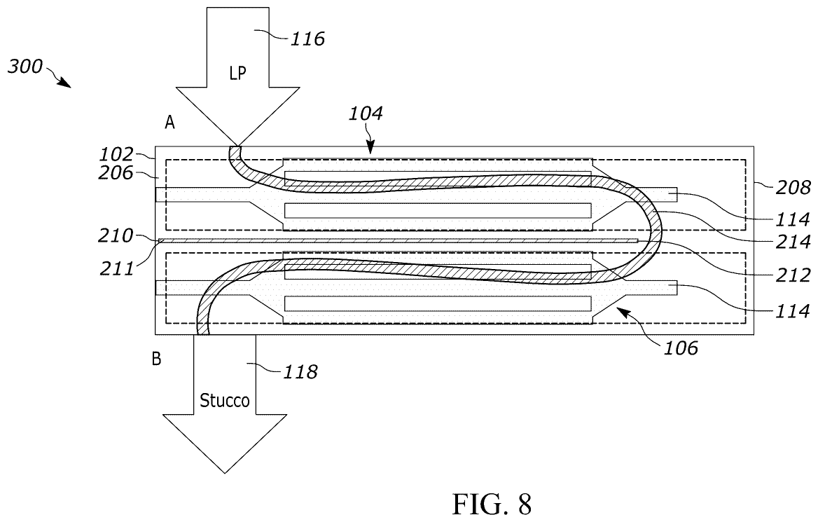

FIG. 8 is a schematic top view of another implementation of an apparatus 300 in accordance with the teaching of this disclosure. The apparatus 300 includes all of the same features as the apparatus 100 of FIG. 1. The apparatus 300 is thus similar to the apparatus 200 of FIG. 7 but includes two burner assemblies 104, 106 instead of four burner assemblies. As such, the apparatus 300 of FIG. 8 only includes a single baffle 210. The baffle 210 is coupled to the first lateral wall 206 and extends between the serpentine burner conduits 114 of the first and second burner assemblies 104, 106. The baffle 210 is spaced from the second lateral wall 208. The baffle 210 includes a flat metal plate with a first edge 211 connected to the first lateral wall 206, and an opposite second edge 212 spaced from the opposite second lateral wall 208. A bottom edge of the baffle 210 and a top edge of the baffle 210 may be floating in some examples. The bottom edge of the baffle 210 may be floating in some examples to allow the agitation assembly 124 to move below and relative to the baffle 210. The top edge of the baffle 210 may be coupled to the top of the housing 102 and/or may be free floating.

Similar to that described in reference to FIG. 7, the baffle 210 encourages the flow of gypsum through the housing 102 along a tortuous path generally indicated by arrow 214 in FIG. 8. So configured, the gypsum flows from the inlet 116, along and past the first burner assembly 114, and through the space between the baffle 210 and the second lateral wall 208. Then, the gypsum flows along and past the second burner assembly 114, and to the outlet 118. Thus, the baffle 210 directs the flow of the gypsum by restricting flow to the desired flow path 214. The flow of the gypsum in a direction generally indicated by the arrow 214 may be referred to as “plug flow.” The gypsum flowing in this manner may allow for more uniform heating of the gypsum and/or more uniform gypsum conversion, thereby avoiding some gypsum being over cooked and some gypsum being under cooked.

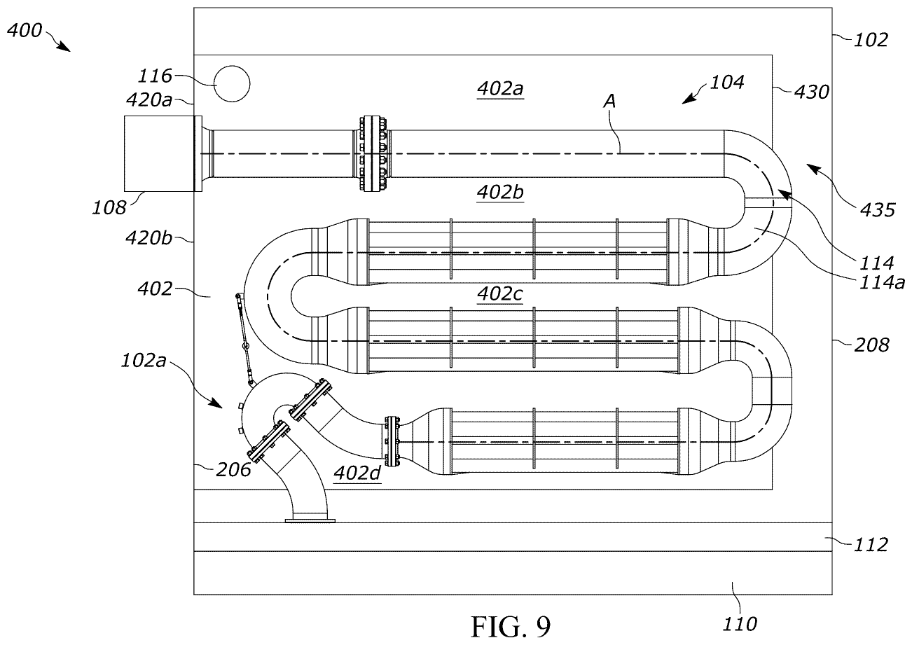

FIG. 9 is a side view of another implementation of an apparatus 400 in accordance with the teaching of this disclosure. The apparatus 400 includes all of the same features as the apparatus 100 of FIG. 1 but only a single burner assembly 104 and also a baffle 402. More specifically, the apparatus 400 includes a housing 102, a single burner assembly 104 including a serpentine burner conduit 114, a fluidization plenum 110, and an agitation assembly 112. The housing 102 includes a first lateral wall 206 and a second lateral wall 208. The housing 102 can also include other walls not expressly identified in FIG. 9 enclosing the interior of the housing 102. In FIG. 9, the baffle 402 is constructed of four (4) flat metal plate portions 402a, 402b, 402c, and 402d, each cut and shaped to fit adjacent to corresponding contours of the serpentine burner conduit 114.

In FIG. 9, the flat metal plate portions 402a, 402b, 402c, and 402d are fixed to the housing 102 and/or the serpentine burner conduit 114 such that the baffle 402 is disposed in a vertical plane that extends through a central longitudinal axis A of the serpentine burner conduit 114. As illustrated, the first and second flat metal plate portions 402a, 402b of the baffle 402 include straight edges 420a, 420b coupled to the first lateral wall 206. The baffle 402, as mentioned, extends through the housing 102 away from the first lateral wall 206 to a terminal edge 430 that is separated from the second lateral wall 208 by a space 435. The baffle 402 directs the flow of gypsum through the housing 102, around the baffle 402, and the serpentine burner conduit 114.

Collectively, the flat metal plate portions 402a, 402b, 402c, and 402d define a quadrilateral shaped (e.g., a rectangle or square) outer edge of the baffle 402 such that the baffle 402 divides the housing 102 vertically into two co-equal volumetric portions, i.e., a first portion 102a on one side of the serpentine burner conduit 114 and a second portion (not shown in FIG. 9, as it is behind the baffle 402) on the opposite side of the serpentine burner conduit 114. In other versions, the flat metal plate portions 402a, 402b, 402c, and 402d can collectively define a shape other than a quadrilateral. Because the baffle 402 is disposed vertically along the central longitudinal axis A of the serpentine burner conduit 114, the serpentine burner conduit 114 includes a first half 114a disposed in the first portion 102a of the housing 102 and a second half (not shown) disposed on the opposite side of the baffle 402 in the second portion of the housing 102. The first half 114a and the second half of the serpentine burner conduit 114 are generally mirror images of each other.

As further illustrated in FIG. 9, the apparatus 400 includes an inlet 116 positioned on a side of the housing 102 and which is configured to receive gypsum into the first portion 102a of the housing 102. So configured, during operation, gypsum flows into the first portion 102a of the housing 102 via the inlet 116, along and past the first half 114a of the serpentine burner conduit 114 and through the space 435 between the terminal edge 430 of the baffle 402 and the second lateral wall 208. Then, the gypsum flows into and through the second portion of the housing 102 (i.e., on the opposite side of the baffle 402), along and past the second half of the serpentine burner conduit 114, and to an outlet disposed on an opposite side of the housing 102. As with previously disclosed embodiments, the baffle 402 thus directs the flow of the gypsum by restricting flow to a desired flow path. Such flow may be referred to as “plug flow.” The gypsum flowing in this manner may allow for more uniform heating of the gypsum and/or more uniform gypsum conversion, thereby avoiding some gypsum being over cooked and some gypsum being under cooked.

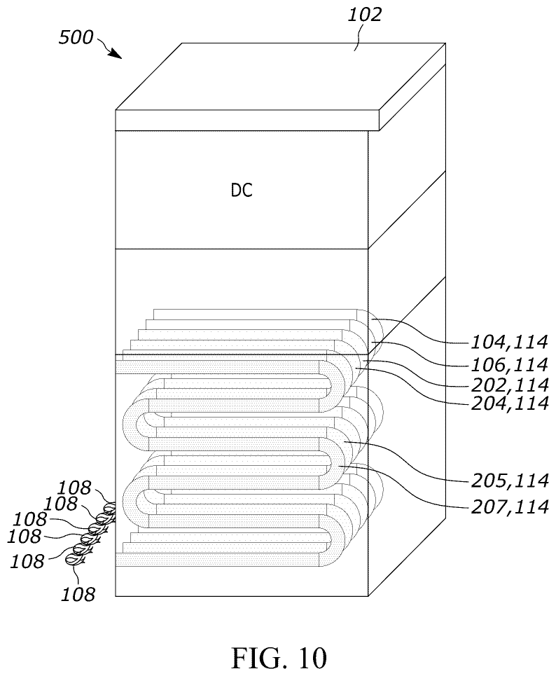

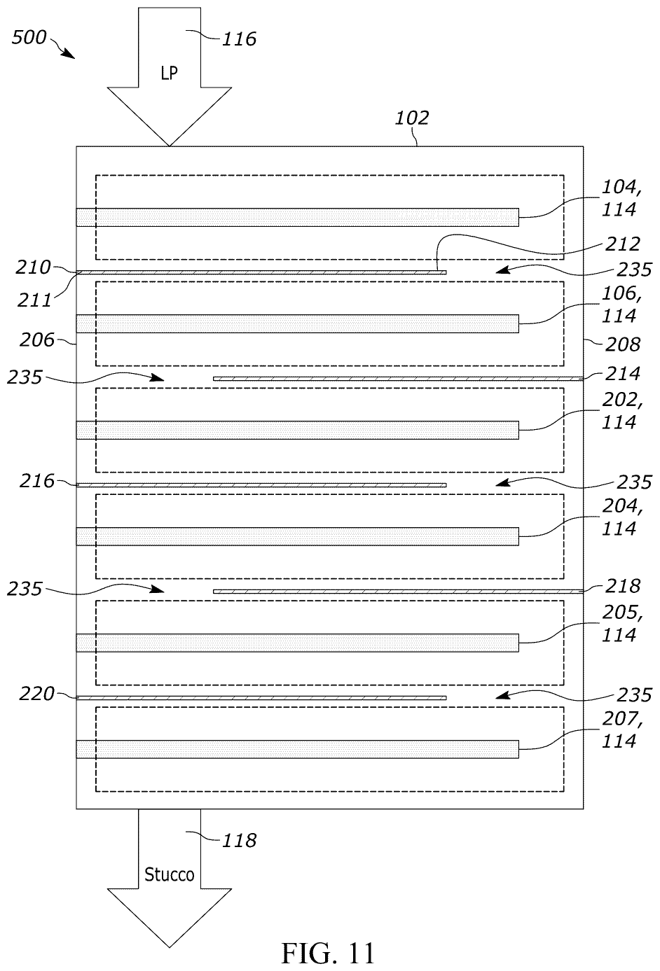

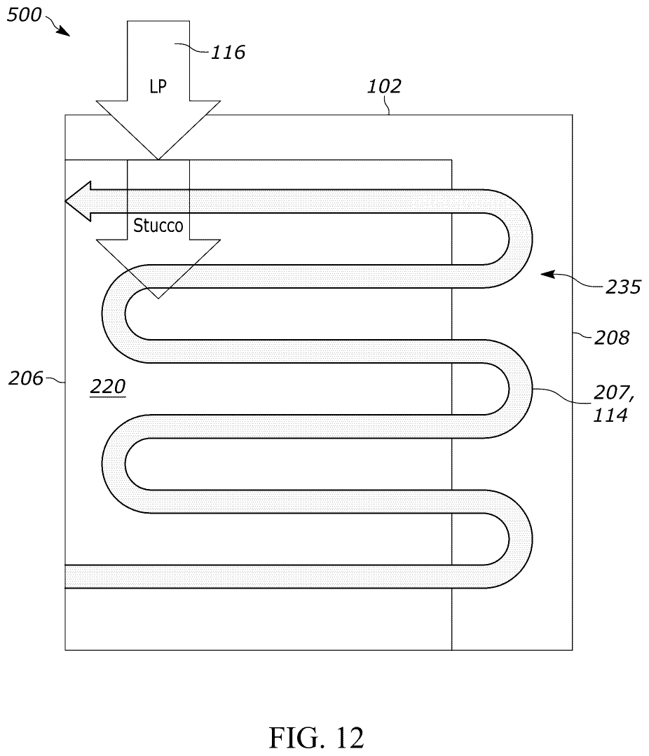

FIGS. 10-12 depict yet another implementation of an apparatus 500 in accordance with the teaching of this disclosure. FIG. 10 is a perspective view of the apparatus 500. FIG. 11 is a top view of the apparatus 500. And FIG. 12 is a side view of the apparatus 500. The apparatus 500 includes similar features as the apparatus described above in FIG. 1 but for three primary distinctions. First, the apparatus in FIGS. 10-12 includes six (6) burner assemblies 104, 106, 202, 204, 205, 207 instead of two burner assemblies 104, 106 as in FIG. 1. In other embodiments, the apparatus 500 could include more or less than six (6) burner assemblies. Second, the apparatus 500 in FIGS. 10-12 includes baffles 212, 214, 216, 218, 220 (removed from FIG. 10 for clarity; see FIGS. 11 and 12) disposed between the burner assemblies 104, 106, 202, 204, 205, 207, similar to the alternating baffles of FIG. 7. And third, each burner assembly 104, 106, 202, 204, 205, 207 includes a burner 108 disposed proximate to a bottom of the housing 102 as opposed to proximate a top of the housing 102 as in FIG. 1. With the burners 108 disposed at the bottom of the housing 102, the lowest portions of the serpentine burner conduits 114 most proximate to the burners 108 will have the highest temperature, while the higher portions of the serpentine burner conduits 114 will have the lowest temperature. Therefore, one advantage of this configuration provides a staged cross-flow configuration, where the most heat rises from the lower portions of the serpentine burner conduits 114 through the housing 102 to further cook the gypsum. And even though the burners 108 are disposed at the bottom of the housing 102, the apparatus 500 can still include a fluidization plenum and an agitation frame, as disclosed, for example, in FIGS. 1-6. However, because the burners 108 are at the bottom, the serpentine burner conduits 114 may exit the housing 102 proximate the top of the apparatus 500, in which case additional piping external to the housing 102, for example, may be required to convey the exhaust gas from adjacent the top of the housing 102 back down to the fluidization plenum at the bottom.

As with the burner assemblies 104, 106 described above with reference to FIG. 1, each burner assembly 104, 106, 202, 204, 205, 207 in FIGS. 10-12 includes a burner, a fluidization plenum, an agitation frame, and a serpentine burner conduit. However, in alternative versions, it is possible that any one of more of the burner assemblies 104, 106, 202, 204, 205, 207 in FIGS. 10-12 can share a burner, a fluidization plenum, and/or an agitation frame. The housing 102 of the apparatus 500 has a first lateral wall 206, a second lateral wall 208, and other walls not shown which enclose the interior of the housing 102. The apparatus 500 further includes a first baffle 210, a second baffle 214, a third baffle 216, a fourth baffle 218, and a fifth baffle 220. The first baffle 210 is coupled to the first lateral wall 206 and extends between the serpentine burner conduits 114 of the first and second burner assemblies 104, 106. The first baffle 210 includes a flat metal plate with a first edge 211 connected to the first lateral wall 206, and an opposite second edge 212 spaced from the opposite lateral wall 208 by a space 235. A bottom edge of the first baffle 210 and a top edge of the first baffle 210 may be floating in some examples. The bottom edge of the first baffle 210 may be floating in some examples to allow the agitation assembly 124 to move below and relative to the first baffle 210. The top edge of the first baffle 210 may be coupled to the top of the housing 102 and/or may be free floating.

The second baffle 214 is generally constructed the same as the first baffle 210, but it is coupled to the second lateral wall 208 and is spaced from the first lateral wall 206 by a space 235, extending between the serpentine burner conduits 114 of the second and third burner assemblies 106, 202. The third baffle 216 is also generally constructed the same as the first and second baffles 210, 214, but like the first baffle 210, the third baffle 216 is coupled to the first lateral wall 206 and is spaced from the second lateral wall 208 by a space 235, extending between the serpentine burner conduits 114 of the third and fourth burner assemblies 202, 204. The fourth baffle 218 is constructed the same as the second baffle 212, as it is coupled to the second lateral wall 208 and is spaced from the first lateral wall 206 by a space 235, extending between the serpentine burner conduits 114 of the fourth and fifth burner assemblies 204, 205. Finally, the fifth baffle 220 is constructed the same as the first and third baffles 210, 216, as it is coupled to the first lateral wall 206 and is spaced from the second lateral wall 208 by a space 235, extending between the serpentine burner conduits 114 of the fifth and sixth burner assemblies 205, 207. In the implementation of FIGS. 10-12, the baffles 210, 214, 216, 218, 220 may be referred to as vertical baffles. And as the baffles 212, 214, 216, 218, 220 alternatingly extend from opposite first and second lateral walls 206, 208 of the housing 102, this arrangement can be described as including alternating baffles.

The baffles 212, 214, 216, 218, 220 encourage the flow of gypsum through the housing 102 along a path between and around the baffles 212, 214, 216, 218, 220. So configured, the gypsum flows from the inlet 116, along and past the first burner assembly 104, and through the space between the first baffle 210 and the second lateral wall 208. Then, the gypsum flows along and past the second burner assembly 106, and through the space between the second baffle 214 and the first lateral wall 206. Then, the gypsum flows along and past the third burner assembly 202, and through the space between the third baffle 216 and the second lateral wall 208. Then, the gypsum flows along and past the fourth burner assembly 204, and through the space between the fourth baffle 218 and the first lateral wall 206. Then, the gypsum flows along and past the fifth burner assembly 205, and through the space between the fifth baffle 220 and the second lateral wall 208. And finally, the gypsum flows along and past the sixth burner assembly 207, and to the outlet 118. Thus, the baffles 212, 214, 216, 218, 220 direct the flow of the gypsum by restricting flow to the desired flow path. The flow of the gypsum may be referred to as “plug flow.” The gypsum flowing in this manner may allow for more uniform heating of the gypsum and/or more uniform gypsum conversion, thereby avoiding some gypsum being over cooked and some gypsum being under cooked.

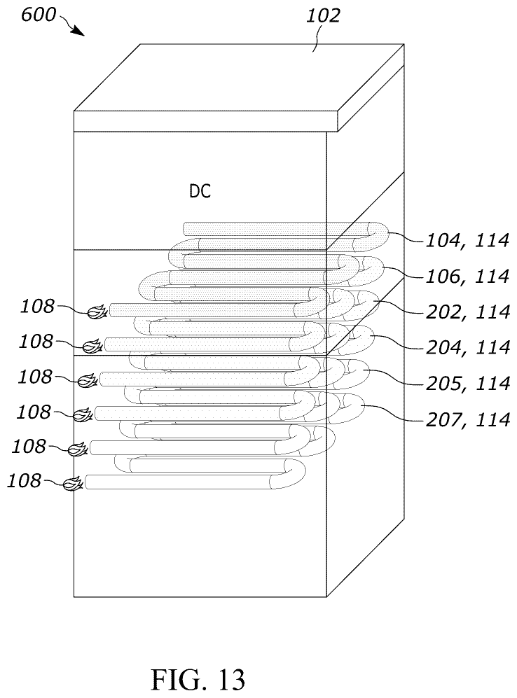

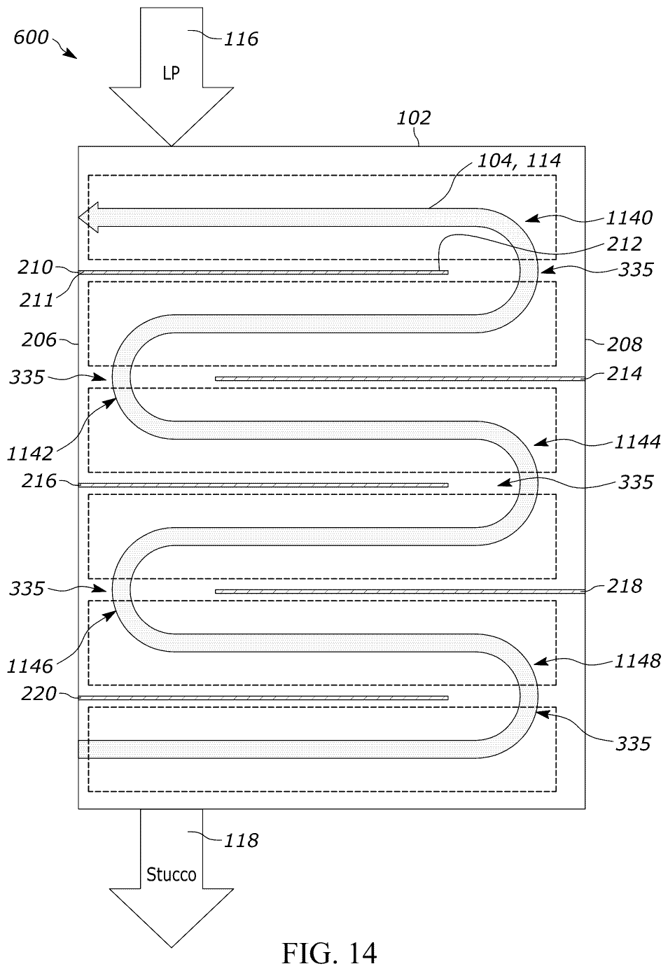

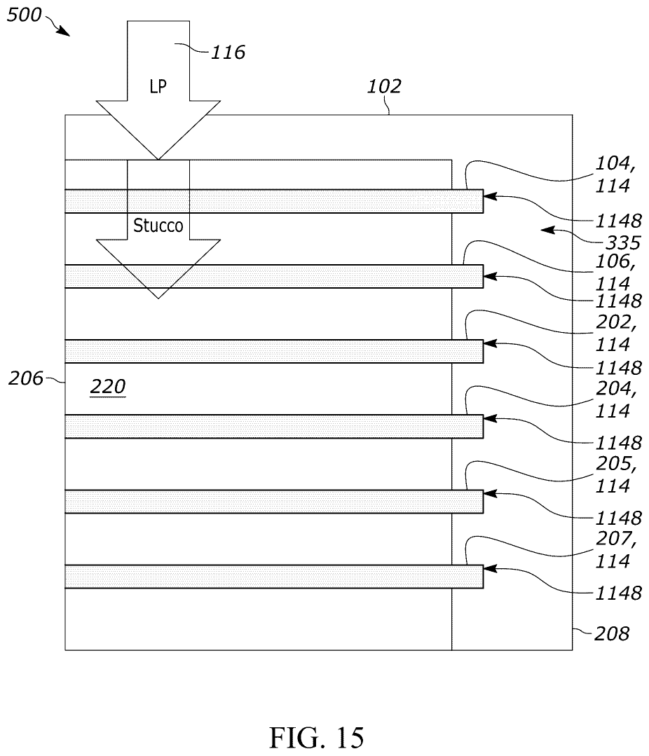

FIGS. 13-15 depict yet another implementation of an apparatus 600 in accordance with the teaching of this disclosure. FIG. 13 is a perspective view of the apparatus 600. FIG. 14 is a top view of the apparatus 600. And FIG. 15 is a side view of the apparatus 600. The apparatus 600 includes similar features as the apparatus described above in FIGS. 10-12 but for the orientation of the burner assemblies 104, 106, 202, 204, 205, 207 and the serpentine burner conduits 114. That is, in FIGS. 10-12, the burner assemblies 104, 106, 202, 204, 205, 207 are arranged such that the serpentine burner conduits 114 extend vertically through the housing 102. In contrast, in FIGS. 13-15, the burner assemblies 104, 106, 202, 204, 205, 207 are arranged such that the serpentine burner conduits 114 extend horizontally through the housing 102. Additionally, because the serpentine burner conduits 114 extend horizontally through the housing 102, the burners 108 are not all located at the bottom of the housing 102, but rather, as can be seen in FIG. 13, the burners 108 are stacked in vertical alignment and corresponding arrangement with the respective burner assemblies 104, 106, 202, 204, 205, 207.

Furthermore, even though the burners 108 are disposed in a vertically stacked arrangement, the apparatus 600 can still include a fluidization plenum and an agitation frame, as disclosed, for example, in FIGS. 1-6. However, because the burners 108 are stacked vertically and the serpentine burner conduits 114 are oriented horizontally, the serpentine burner conduits 114 may also exit the housing 102 a vertically staked arrangement on the opposite side of the housing 102 such that additional piping external to the housing, for example, may be required to convey the exhaust gas from the serpentine burner conduits 114 down to the fluidization plenum at the bottom of the housing 102.

As with the burner assemblies 104, 106 described above with reference to FIG. 1, each burner assembly 104, 106, 202, 204, 205, 207 in FIGS. 13-15 includes a burner, a fluidization plenum, an agitation frame, and a serpentine burner conduit. However, in alternative versions, it is possible that any one of more of the burner assemblies 104, 106, 202, 204, 205, 207 in FIGS. 13-15 can share a burner, a fluidization plenum, and/or an agitation frame. The housing 102 of the apparatus 600 has a first lateral wall 206, a second lateral wall 208, and other walls not shown which enclose the interior of the housing 102. The apparatus 600 further includes a first baffle 210, a second baffle 214, a third baffle 216, a fourth baffle 218, and a fifth baffle 220.

As can be seen in FIG. 14, for example, the first baffle 210 is coupled to the first lateral wall 206 and extends into first U-shaped portions 1140 of the serpentine burner conduits 114 of all burner assemblies 104, 106, 202, 204, 205, 207. The first baffle 210 includes a flat metal plate with a first edge 211 connected to the first lateral wall 206, and an opposite second edge 212 spaced from the opposite lateral wall 208 by a space 335. A bottom edge of the first baffle 210 and a top edge of the first baffle 210 may be floating in some examples. The bottom edge of the first baffle 210 may be floating in some examples to allow the agitation assembly 124 to move below and relative to the first baffle 210. The top edge of the first baffle 210 may be coupled to the top of the housing 102 and/or may be free floating.

The second baffle 214 is generally constructed the same as the first baffle 210, but it is coupled to the second lateral wall 208 and is spaced from the first lateral wall 206 by a space 335, extending into second U-shaped portions 1142 of the serpentine burner conduits 114 of all burner assemblies 104, 106, 202, 204, 205, 207. The third baffle 216 is also generally constructed the same as the first and second baffles 210, 214, but like the first baffle 210, the third baffle 216 is coupled to the first lateral wall 206 and is spaced from the second lateral wall 208 by a space 335, extending into third U-shaped portions 1144 of the serpentine burner conduits 114 of all burner assemblies 104, 106, 202, 204, 205, 207. The fourth baffle 218 is constructed the same as the second baffle 212, as it is coupled to the second lateral wall 208 and is spaced from the first lateral wall 206 by a space 335, extending into fourth U-shaped portions 1146 of the serpentine burner conduits 114 of all burner assemblies 104, 106, 202, 204, 205, 207. Finally, the fifth baffle 220 is constructed the same as the first and third baffles 210, 216, as it is coupled to the first lateral wall 206 and is spaced from the second lateral wall 208 by a space 335, extending into fifth U-shaped portions 1146 of the serpentine burner conduits 114 of all burner assemblies 104, 106, 202, 204, 205, 207. In the implementation of FIGS. 13-15, the baffles 210, 214, 216, 218, 220 may be referred to as vertical baffles. And as the baffles 212, 214, 216, 218, 220 alternatingly extend from opposite first and second lateral walls 206, 208 of the housing 102, this arrangement can be referred to as including alternating baffles.

The baffles 212, 214, 216, 218, 220 encourage the flow of gypsum through the housing 102 along a path between and around baffles 212, 214, 216, 218, 220. So configured, the gypsum flows from the inlet 116, toward and along the first U-shaped portions 1140 of the serpentine burner conduits 114, including through the space between the first baffle 210 and the second lateral wall 208. Then, the gypsum flows toward and along the second U-shaped portions 1142 of the serpentine burner conduits 114, including through the space between the second baffle 214 and the first lateral wall 206. Then, the gypsum flows toward and along the third U-shaped portions 1144 of the serpentine burner conduits 114, including through the space between the third baffle 216 and the second lateral wall 208. Then, the gypsum flows toward and along the fourth U-shaped portions 1146 of the serpentine burner conduits 114, including through the space between the fourth baffle 218 and the first lateral wall 206. Then, the gypsum flows toward and along the fifth U-shaped portions 1148 of the serpentine burner conduits 114, including through the space between the fifth baffle 220 and the second lateral wall 208. And finally, the gypsum flows to the outlet 118. Thus, the baffles 210, 214, 216, 218, 220 direct the flow of the gypsum by restricting flow to the desired flow path. The flow of the gypsum may be referred to as “plug flow.” The gypsum flowing in this manner may allow for more uniform heating of the gypsum and/or more uniform gypsum conversion, thereby avoiding some gypsum being over cooked and some gypsum being under cooked.

The configuration of the horizontal burner assemblies 104, 106, 202, 204, 205, 207 in FIGS. 13-15 in combination with the alternating vertical baffles 210, 214, 216, 218, 220 can advantageously create a counter flow through the housing 102 of the apparatus 600 where the portions of the serpentine burner conduits 114 most proximate to the burners 108, which also corresponds to a portion of the housing 101 proximate to the outlet 118, have the highest temperature. Moreover, the portions of the serpentine burner conduits 114 most removed from the burners 108, which also corresponds to the portion of the housing 102 proximate to the inlet 116, have the lowest temperature. The heat flow generated by this arrangement can generate a true counter current which can advantageously ensure effective and highly efficient heat transfer from the serpentine burner conduits 114 to the gypsum.

While various embodiments of apparatuses are disclosed herein with different numbers of burner assemblies, it should be appreciated that the scope of the disclosure is not limited to apparatuses having any specific number of burner assemblies. That is, the present disclosure includes apparatuses with one burner assembly, two burner assemblies, and any number greater than two burner assemblies.

Furthermore, while the apparatuses in FIGS. 7 and 10-12 include alternating baffles disposed between each adjacent pair of burner assemblies, the scope of the disclosure includes similar apparatuses with less baffles including only a single vertical baffle, for example, even where there are three or more burner assemblies.

Further yet, while the embodiment of FIGS. 13-15 includes one baffle in each U-shaped portion of the horizontally stacked burner assemblies, an alternative embodiment may include only a single baffle disposed in only a single U-shaped portion or multiple baffles disposed in less than all U-shaped portions.

While several examples have been disclosed herein, any features from any examples may be combined with or replaced by other features from other examples. Moreover, while several examples have been disclosed herein, changes may be made to the disclosed examples without departing from the scope of the claims.

What is claimed is:

1. An apparatus for calcining gypsum, the apparatus comprising:
a housing having opposite first and second lateral walls, an inlet, and an outlet;
at least one burner assembly connected to the housing, the burner assembly comprising:
a burner,
a fluidization plenum, and
a serpentine burner conduit at least partly extending through the housing and to the fluidization plenum; and
at least one baffle disposed in the housing, the baffle attached to one of the first and second lateral walls and extending at least partly across the housing toward the other of the first and second lateral walls to define a flow path for the gypsum, the flow path extending from the inlet, around the baffle, and to the outlet.

2. The apparatus of claim 1, wherein the at least one burner assembly includes at least first and second vertical burner assemblies comprising respective first and second vertical serpentine burner conduits, and wherein the baffle is a vertical baffle disposed at least partly between the first and second vertical serpentine burner conduits.

3. The apparatus of claim 1, wherein the at least one burner assembly includes at least one horizontal burner assembly comprising a horizontal serpentine burner conduit, and wherein the baffle is a vertical baffle disposed at least partly in a U-shaped portion of the horizontal serpentine burner conduit.

4. The apparatus of claim 3, wherein the at least one horizontal burner assembly includes at least first and second horizontal burner assemblies comprising respective first and second horizontal serpentine burner conduits, and wherein the vertical baffle is disposed at least partly in corresponding U-shaped portions of the first and second serpentine burner conduits.

5. The apparatus of claim 1, wherein the at least one burner assembly includes a single burner assembly comprising a single serpentine burner conduit, and wherein the baffle comprises a plurality of flat metal plate portions dividing the housing into separate first and second housing portions, the single serpentine burner conduit comprising a first half disposed in the first housing portion and a second half disposed in the second housing portion.

6. The apparatus of claim 1, wherein the at least one burner assembly comprises at least first, second, and third burner assemblies including corresponding first, second, and third serpentine burner conduits, and wherein the at least one baffle comprises first and second baffles, the first baffle attached to the first lateral wall and extending at least partly across the housing toward the second lateral wall between the first and second serpentine burner conduits, and the second baffle attached to the second lateral wall and extending at least partly across the housing toward the first lateral wall between the second and third serpentine burner conduits.

7. The apparatus of claim 1, wherein the at least one burner assembly comprises at least first, second, and third burner assemblies including corresponding first, second, and third serpentine burner conduits, and wherein the at least one baffle comprises first and second baffles, the first baffle attached to the first lateral wall and extending at least partly across the housing toward the second lateral wall and within corresponding first U-shaped portions of the first and second serpentine burner conduits, and the second baffle attached to the second lateral wall and extending at least partly across the housing toward the first lateral wall and within corresponding second U-shaped portions of the first and second serpentine burner conduits.

8. The apparatus of claim 1, wherein the burner of the at least one burner assembly is located proximate a top of the housing, proximate a bottom of the housing, or proximate a side of the housing.

9. The apparatus of claim 1, wherein the at least one burner assembly comprises first and second burner assemblies comprising corresponding first and second serpentine burner conduits, and the first and second burner assemblies further comprise corresponding first and second fluidization plenums such that the first and second serpentine burner conduits exhaust into the corresponding first and second fluidization plenums, the first and second fluidization plenums separated from one another.

10. The apparatus of claim 9, further comprising a space disposed between the first and second fluidization plenums.

11. The apparatus of claim 9, further comprising a divider disposed between the fluidization plenums.

12. A method of calcining gypsum, the method comprising:
providing gypsum to an inlet of a housing of a calcining apparatus;
directing the flow of gypsum through the housing and around at least one baffle disposed in the housing, the baffle attached to one of a first and a second lateral wall of the housing and extending at least partly across the housing toward the other of the first and second lateral walls;
heating the gypsum via conduction heat transfer with at least one serpentine burner conduit disposed in the gypsum in the housing as the gypsum is directed through the housing and around the at least one baffle, the serpentine burner conduit extending from a burner and through the housing;
flowing exhaust gas from the serpentine burner conduit through a fluidization plenum disposed adjacent a bottom wall of the housing; and
fluidizing and further heating the gypsum via convection heat transfer by flowing the exhaust gas from the at least one serpentine burner conduit through the gypsum in the housing.

13. The method of claim 12, wherein directing the flow of gypsum comprises directing the flow of gypsum around at least one vertical baffle disposed at least partly between at least two vertical serpentine burner conduits.

14. The method of claim 12, wherein directing the flow of gypsum comprises directing the flow of gypsum around at least one vertical baffle disposed at least partly in a U-shaped portion of the least one serpentine burner conduit.

15. The method of claim 12, wherein directing the flow of gypsum comprises directing the flow of gypsum around at least one vertical baffle comprising a plurality of flat metal plate portions dividing the housing into separate first and second housing portions, and around a single serpentine burner conduit comprising a first half disposed in the first housing portion and a second half disposed in the second housing portion.

16. The method of claim 12, wherein directing the flow of gypsum comprises directing the flow of gypsum around at least first and second baffles, the first baffle attached to the first lateral wall and extending at least partly across the housing toward the second lateral wall between a first serpentine burner conduit and a second serpentine burner conduit, and the second baffle attached to the second lateral wall and extending at least partly across the housing toward the first lateral wall between the second serpentine burner conduit and a third serpentine burner conduit.

17. The method of claim 12, wherein directing the flow of gypsum comprises directing the flow of gypsum around at least first and second baffles, the first baffle attached to the first lateral wall and extending at least partly across the housing toward the second lateral wall and within a first U-shaped portion of at least first and second serpentine burner conduits, and the second baffle attached to the second lateral wall and extending at least partly across the housing toward the first lateral wall and within a second U-shaped portion of the at least first and second serpentine burner conduits.

18. The method of claim 12, wherein heating the gypsum comprises heating a plurality of serpentine burner conduits with a plurality of corresponding burners located proximate a top of the housing, proximate a bottom of the housing, or proximate a side of the housing.

19. The method of claim 12, wherein heating the gypsum comprises heating the gypsum with at least two serpentine burner conduits and wherein flowing exhaust gas from the at least two serpentine burner conduits comprises flowing the exhaust gas through at least two fluidization plenums separated from one another.

20. The method of claim 19, wherein flowing exhaust gas through at least two fluidization plenums comprises flowing exhaust gas through at least two thermally isolated fluidization plenums.
